(19) United States
(12) Patent Application Publication
(10) Pub. No.: US 2011/0084039 A1
(43) Pub. Date: Apr. 14, 2011

(54) SURGICAL FIELD ORGANIZER

(75) Inventors: Michael W. WALTERS, Marshall, MI (US); Jeffrey L. CORNELL, Coldwater, MI (US); David R. MEAD, Marshall, MI (US); Michael S. SMITH, Hastings, MI (US)

(73) Assignee: PROGRESSIVE DYNAMICS, INC., Marshall, MI (US)

(21) Appl. No.: 12/578,800

(22) Filed: Oct. 14, 2009

(51) Int. Cl. A47F 7/00; B65D 85/00; F16L 3/08

(52) U.S. Cl. 211/85.13; 206/525; 211/70.6; 248/65

(57) ABSTRACT

An organizer for surgical instruments and the like comprising a T-shaped plastic body defining an interior channel having two inlets and an outlets, a cover for the channel which may be hingedly attached to the body or connected by way of snap fittings. A plurality of split cylinder instrument holders are mounted to the top surface of the cover in side-by-side parallel relationship to receive and hold elongate instruments or tools with flexible tubes, hoses or cables gathered and held in the body channel. Two-sided tape may be used to secure the organizer to a surgical drape. The organizer is preferably packaged in a sterile condition inside of a hermetically-sealed plastic package.

### FIELD OF THE INVENTION

This invention relates to equipment organizers for use in a surgical field and more particularly to a device which may be adhered to a surgical field drape to provide a fixed organizer for hoses, cables and other flexible connectors and which, at the same time, provides a convenient and secure resting place for one or more surgical instruments.

### BACKGROUND OF THE INVENTION

An OR surgical site for even relatively simple procedures can be characterized by a large number of hoses, tubes, wires, cables and the like which extend into the surgical field from peripheral sites to supply power, fluids, gasses, suction and data connections to various instruments such as probes, endoscopes, aspirators, Bovies, drills and other handheld instruments. The typical OR situation results in hoses, cables, wires, tubes and the like lying on and around the patient's body, primarily on top of the surgical drape and within the sterile field. Should one or more of these instruments fall outside of the sterile field, it must be replaced before the procedure can be resumed.

### SUMMARY OF THE INVENTION

The present invention provides a simple, economical device susceptible of sterilization and/or sterile packaging which is useful in both organizing and securing the hoses, tubes, cables, wires and other elongate flexible instrument connectors in an organized fashion as well as providing a secure, but readily available, resting place for surgical instruments of the type described above. The invention, therefore, not only contributes to the orderliness of the surgical field, but can facilitate procedures and makes them more efficient.

In general, the device of the present invention comprises a hollow body which defines one or more channels within which a plurality of tubes, hoses, cables and the like can be gathered and held at a central site. The invention further comprises an instrument receiver, either separate or attached in any of several different ways to the channel-forming body, to provide a secure resting plate for one or more instruments. The instrument receiver may, for example, be attached to or formed integrally with a cover plate which is permanently or removably attached to the channel-forming body.

In the preferred form, the instrument receivers are made up of opposed, flexible clips and the entire device is made of plastic which can be sterilized or resterilized. The device is light in weight and inexpensive enough to be disposable. The device preferably has a flat bottom provided with two-sided sterile tape or other fastener system which can be used to secure the body of the device to a surgical drape. The body can take many shapes, several of which are illustrated herein.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views and wherein:

FIG. 1 is a perspective view of a first embodiment of the invention with the cover opened to provide access to a T-shaped channel body having two inlets and an outlet;

FIG. 2 is a perspective view of the device of FIG. 1 also showing the location and physical characteristics of four push-in clamp-type instrument receivers mounted in side-by-side fashion to the top of the cover;

FIG. 3 is a perspective view of a second embodiment wherein the cover, rather than being hinged to the channel body, is completely detachable therefrom;

FIG. 4 is a perspective view of a surgical site showing an embodiment of the invention secured to the surgical drape and holding a number of different surgical instruments;

FIG. 5 is a perspective view of the cover plate for a third embodiment of the invention as it is injection molded;

FIG. 6 is a perspective view of a complete third embodiment showing the cover plate of FIG. 5 folded and snapped into its final configuration and attached by tape to the top of a channel-forming body;

FIG. 7 is a perspective view of a fourth embodiment of the invention; and

FIG. 8 is a perspective view of still another embodiment of the invention with still another body shape.

### DETAILED DESCRIPTION OF THE ILLUSTRATIVE EMBODIMENTS

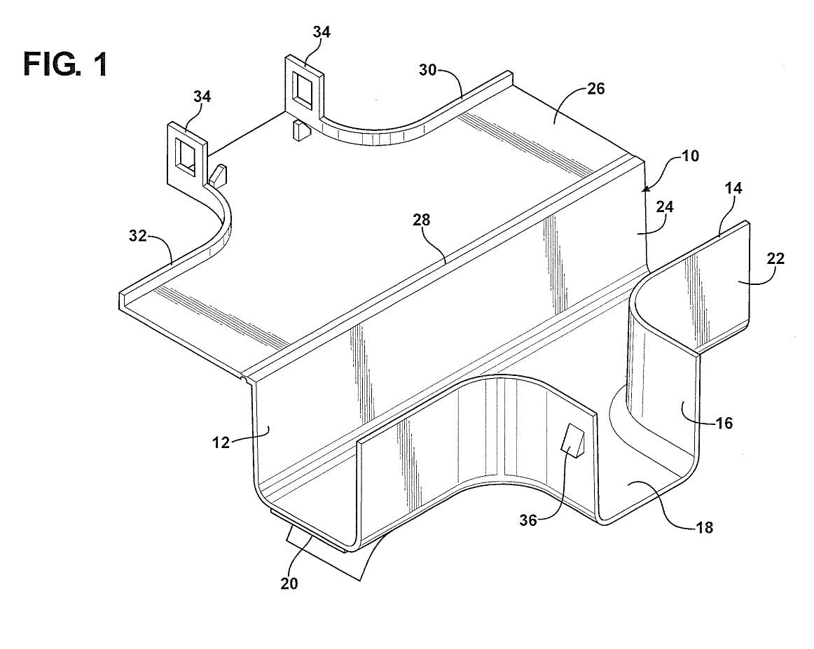

Referring to FIG. 1, there is shown an organizer in the form of a T-shaped plastic body 10 having opposed, in-line inlets 12, 14 and an orthogonal outlet 16. The body 10 is about 5 inches in width and comprises a floor 18 and integral upstanding sidewalls 22, 24. A cover 26 is integrally connected to the body 10 by means of a living hinge 28. The cover exhibits edge flanges 30, 32 terminating in lock frames 34 which receive cam-shaped tabs 36 on the sidewalls 22; only one of the lock tabs 36 is visible in FIG. 1. The cover 26 can be rotated around the axis of the hinge 26 into a position where it closes the T-shaped channel formed in the organizer body 10. The drawing is to scale.

The organizer 10 is preferably made of a suitable plastic such as polypropylene or polyethylene which can be injection molded and which can be autoclaved or otherwise sterilized for use in a surgical field. In practice, it may be sterilized by the manufacturer and shipped in a hermetically sealed, sterile plastic package such as a bag 61 as shown in FIG. 3.

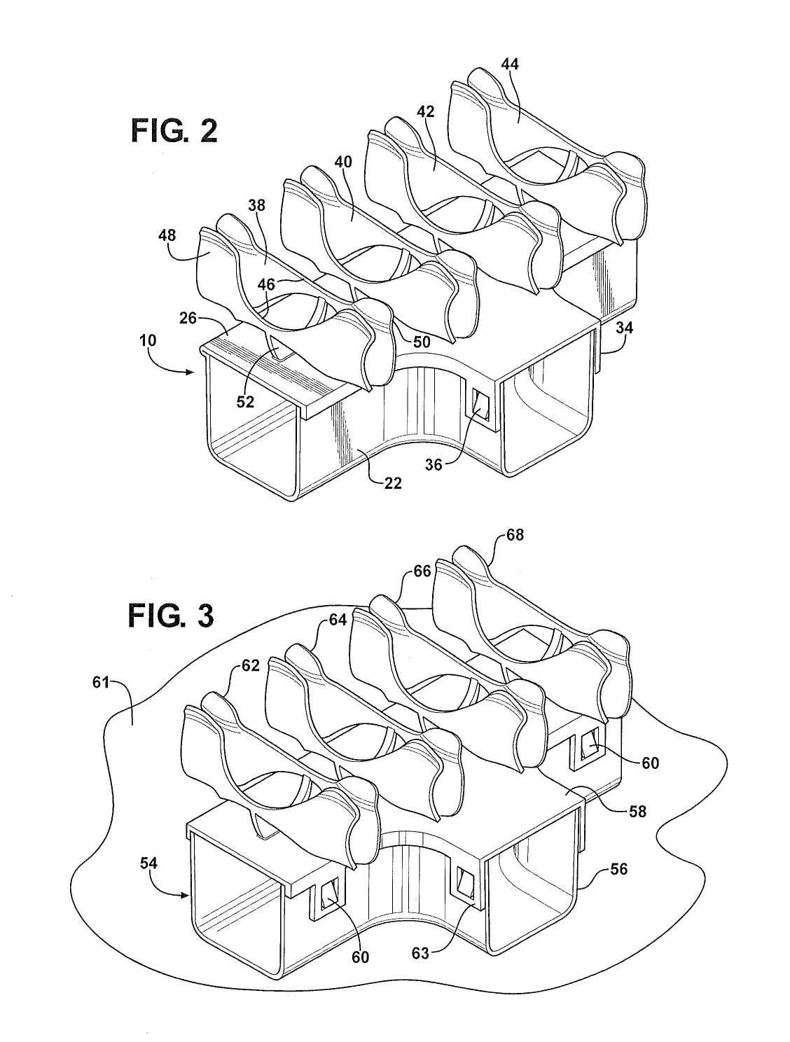

Referring to FIG. 2, the organizer 10 is shown with the cover 26 in a closed position on the lower body and with the latch brackets 34 snapped around the tabs 36.

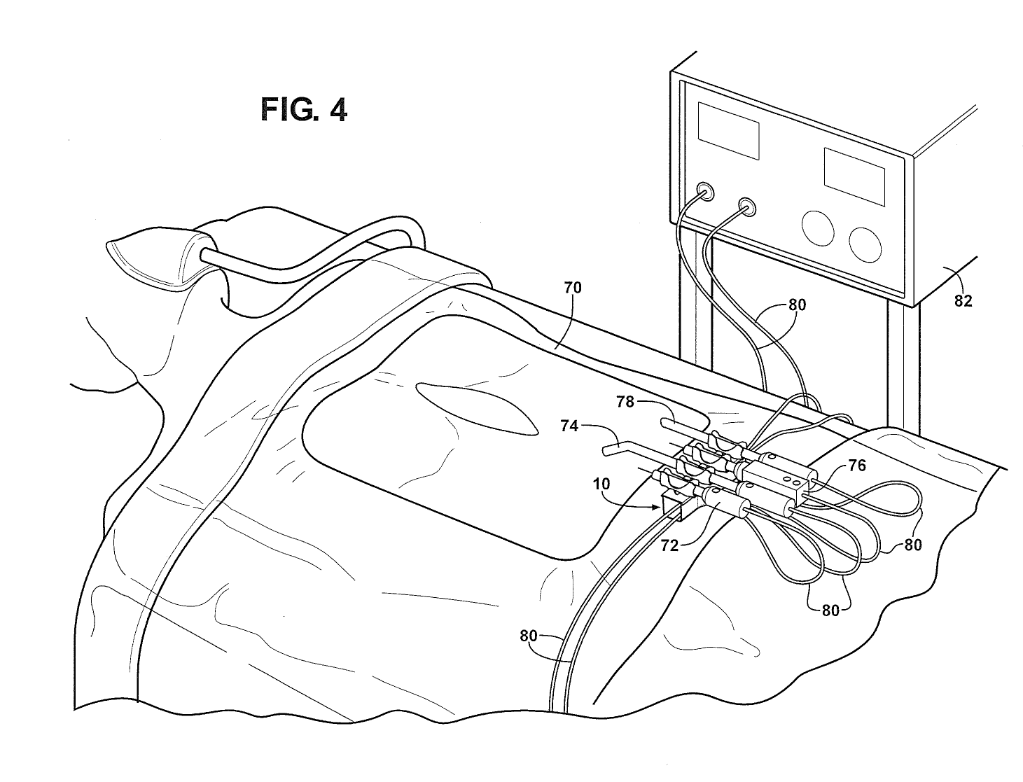

Mounted to the top surface of the cover 26 are flexible push-in type handheld instrument receivers 38, 40, 42 and 44, each of which is made up of two opposed semi-cylindrical clips 46 having raised and spaced apart outwardly flaring labial tabs 48, 50 so that a handheld elongate instrument, such as one of the instruments 72, 74, 76, 78 shown in FIG. 4 can be pushed between the sidewalls 46 and snapped into the receiver 38, 40, 42 or 44 where it is held firmly in position ready for access when needed. The sidewalls 46 are contoured or relieved between the end tabs 48, 50 to permit the barrel of the instrument to be grasped between the fingers and lifted out of the holder 38, 40, 42 or 44 with only appropriate resistance. Each holder side clip 46 has a base 52 used to attach each clip to the top surface of cover 26. The bases preferably snap into holes in the cover in a known manner.

FIG. 3 shows an alternative embodiment of the invention in the form of an organizer 54 having a T-shaped plastic body 56 and a separate T-shaped cover 58 which is secured to the body 56 by means of lock tabs 60 and square frames 63 which receive the tabs 60. There are preferably six such locking arrangements on the organizer 54. Instrument receivers 62, 64, 66 and 68 are arranged in side-by-side, parallel spaced apart relationship and integral with the cover 58 in the same manner as the holders 38, 40, 42 and 44 in the embodiment of FIG. 2. The configuration of the organizer 54 is essentially the same as the configuration of the organizer 10 except for the manner in which the covers are attached to the channel bodies. FIG. 3 also illustrates the organizer 54 packaged in a sterile plastic package, here in the form of a bag 61 which is hermetically sealed at the point of manufacture and opened at the surgical site.

FIG. 4 shows how the organizer 10 is used in a surgical field. The two-sided tape 20 is used to bond the organizer 10 to the surgical drape 70. Of course, hook and loop fasteners, buttons and other fasteners can be substituted for tape 20. Handheld instruments 72, 74, 76 and 78 are shown latched into the receivers 38, 40, 42 and 44. The elongate flexible appendages; e.g., tubes, hoses, cables, wires, data lines and the like, are looped through the T-shaped channel provided by the organizer 10 so that the elongate flexible connectors 80 extend in an organized and secure fashion off to control centers 82 which may be electronic devices, oxygen supplies, computers, displays, power supplies, pumps, fluid bags and other devices typically found in the surgical environment of an OR or clinic.

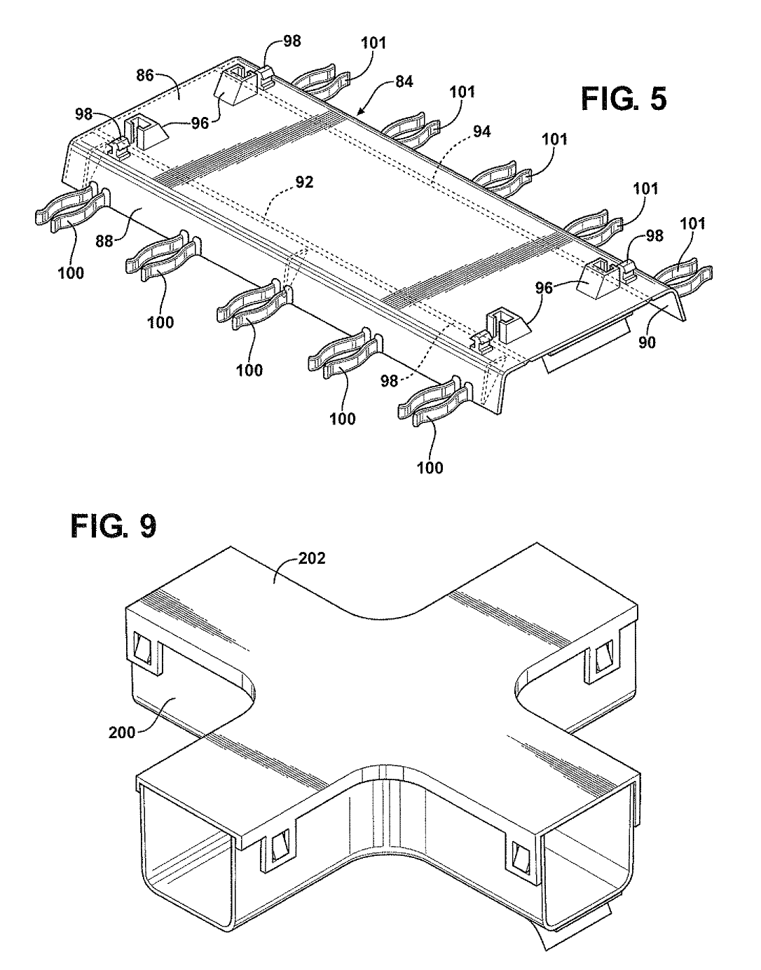

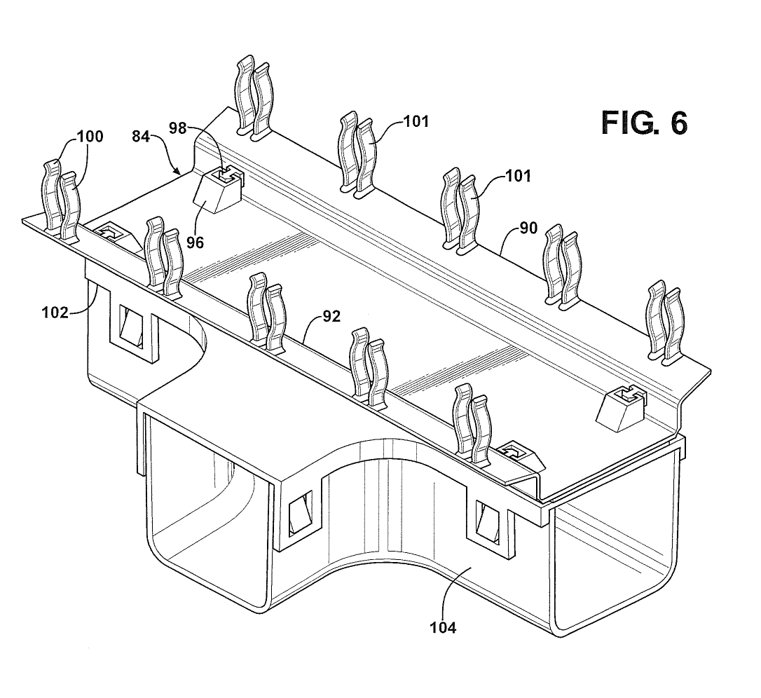

Referring now to FIG. 5, another embodiment of the invention is shown in the form of a molded plastic surgical instrument holder 84 comprising a generally rectangular plastic planar body 86 having laterally opposite, integral, longitudinally extending wing structures 88, 90, each of which is L-shaped in cross-section. The wing members 88, 90 are joined to the body 86 by integral living hinges 92, 94 which run longitudinally and parallel to one another. It is to be understood that FIG. 5 shows the instrument receiver 84 in the configuration corresponding to the design of the mold from which the article is injection molded. It is reconfigured for use as hereinafter described with reference to FIG. 6.

Continuing with the description of the instrument receiver 84, female latch members 96 are molded integrally with the rectangular body 86 inside of the hinges 92, 94 and near the longitudinally opposite ends of the body 86. Male fastener members 98 are molded into the wing members 88, 90 on the outside of the living hinges 92, 94 and immediately adjacent the female fasteners 96 whereby the wing members 88, 90 may be rotated upwardly about the hinges 92, 94 until the male latch members 98 snap into the female latch members 96 to hold wing structures in the rotated and raised position shown in FIG. 6.

Wing member 88 carries five sets of spring clips 100 in uniformly spaced relationship. Similarly, wing member 90 carries five sets of opposed spring clips 101. The clips 100 are directly laterally across from the clips 101 such that when the wing members 88, 90 are raised to the position shown in FIG. 6, the clips 100, 101 form aligned pairs approximately three to four inches apart such that a surgical instrument may be readily nested into and between the aligned pairs of opposed spring clips 100, 101 and held in position ready for use. Again, because the spring clips 100, 101 are several inches apart, the entire center body of the instrument is exposed so that it may be easily grasped by the fingers of the surgeon in use. The device of FIGS. 5 and 6 has an advantage over the FIGS. 1-3 embodiments in that it comprises fewer parts and requires less hand assembly.

FIG. 6 shows how the instrument receiver body 84 can be attached to the cover 102 of a T-shaped flexible connector organizer 104 having generally the configuration of the device shown in FIG. 1. The bottom of the body 86 is flat and can be secured by two-sided tape to the top of the cover 102 or, in the alternative, attached to the surgical drape near the connector organizer 104 such that the two may operated in a concerted fashion despite the fact that they are not directly interconnected.

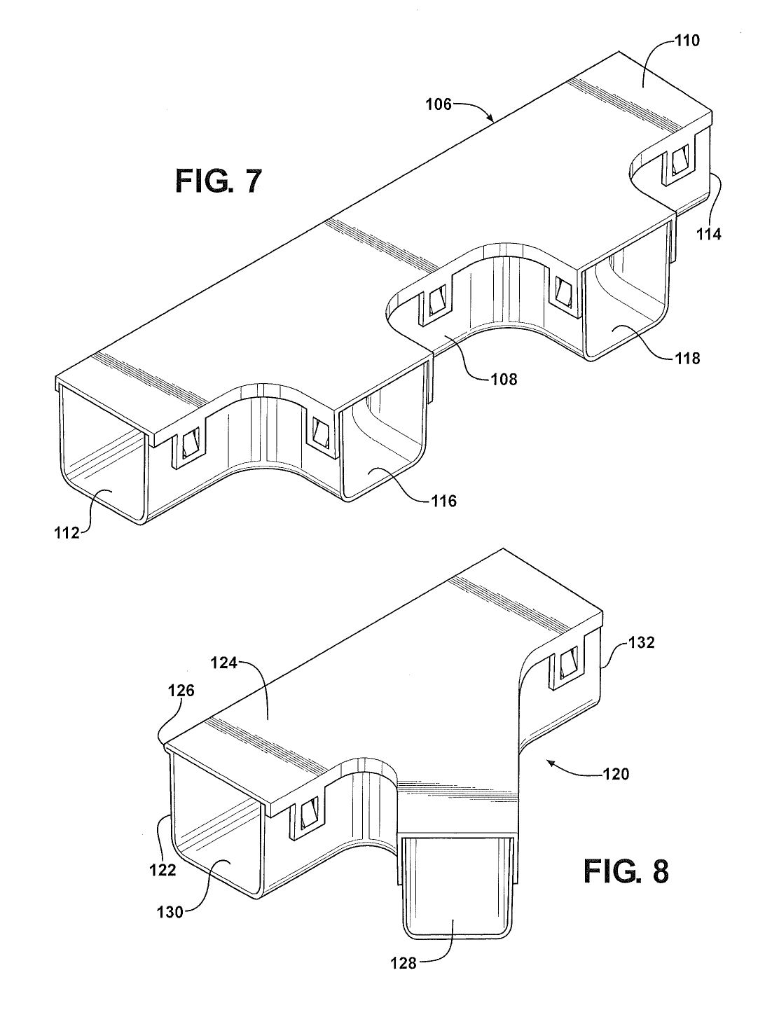

Referring to FIG. 7, there is shown a further embodiment of the invention in the form of a connector organizer 106 which is π-shaped so as to have two inlets 112, 114 and two outlets 106 formed by the combination of the molded plastic body 108 and the hinged clip-on cover 110. The surgical instrument holder may be used in concert with the organizer 106 in the fashion described above; i.e., it may be attached to the cover 110 or integrated into it in the fashion shown in FIG. 2.

FIG. 8 shows a still further embodiment of the invention, this time in the form of an essentially Y-shaped connector organizer 120 having inlets 128, 130 communicating with an outlet 132. The body 122 has a cover 124 which is connected integrally to it by means of a living hinge 126. Again, the cover 124 may be formed separately and attached to the body 122 by snaps and may operate in concert with a surgical instrument receiver of the type shown in either FIG. 2 or FIG. 6. All of the devices shown in FIGS. 5 through 8 may be sterilized and packaged in a sterilized package, such as a plastic bag, shipped from the factory in ready-to-use in the operating room.

It will be apparent from the foregoing that uses of the organizer of the present invention are numerous and extend to dental work, podiatry and non-medical applications such as the organization of computer cables and the like.

What is claimed is:

1. An organizer for instruments, tools and the like having elongate flexible connectors such as hoses and cables attached thereto comprising:
a hollow body defining at least one channel for receiving said connector and having at least one inlet and at least one outlet;
a cover for said body for closing the channel; and
at least one flexible clip type tool or receiver adapted for use with said body.

2. An organizer according to claim 1 wherein the tool receiver is mounted on the cover.

3. An organizer as defined in claim 1 wherein the body has a flat bottom surface which may be attached by adhesive or the like to another surface.

4. An organizer as defined in claim 1 wherein the body is T-shaped.

5. An organizer as defined in claim 1 wherein the body is Y-shaped.

6. An organizer as defined in claim 1 wherein the body has two inlets and two outlets.

7. An organizer as defined in claim 1 wherein the instrument receiver is made in the form of a clip with opposed flexible fingers.

8. An organizer as defined in claim 1 wherein the body and cover are made of plastic.

9. An organizer as defined in claim 1 wherein the body and cover are sterilized.

10. An organizer as defined in claim 2 wherein the cover is attached to the body by a hinge.

11. An organizer for handheld surgical instruments of the type having elongate flexible connectors such as hoses, tubes, wires and cables attached thereto comprising:
a hollow body defining a channel for receiving multiples of said connectors and having an inlet and an outlet, said channel extending between said inlet and outlet;
a cover for closing said channel, said cover having a top surface; and
a plurality of flexible push-in, clip-type surgical instrument receivers attached to said cover top surface in side-by-side, spaced relationship.

12. An organizer as defined in claim 11 wherein the body has a flat bottom surface.

13. An organizer as defined in claim 11 wherein the body is T-shaped and has two inlets and an outlet.

14. An organizer as defined in claim 11 wherein the instrument holders are substantially split cylinders with longitudinal top openings between opposed flexible sidewalls.

15. An organizer as defined in claim 11 which is made of plastic.

16. An organizer as defined in claim 11 wherein the top is connected to the body by means of an integral hinge.

17. A sterilized package comprising a sealed plastic package containing a sterile organizer wherein the organizer comprises a hollow body defining a channel, a cover for closing the channel; and
a plurality of flexible push-in surgical instrument receivers attached to said cover top surface in side-by-side, spaced relationship.

18. A package as defined in claim 17 wherein the organizer is made of a sterilized plastic.

19. A surgical instrument holder comprising:
a planar, molded plastic body having first and second opposite, parallel, longitudinal wings attached to said body by integral hinges;
at least one set of clips attached to each of said wings; and
fastener means for holding the wings in a folded position relative to said body such that the clips are aligned with one another to form an instrument holder.

20. A surgical instrument holder as defined in claim 19 further including a channel-forming body for receiving a flexible connector for a surgical instrument.

21. A surgical instrument holder as defined in claim 20 wherein the plastic body is mounted to the channel-forming body.

22. A T-shaped cable organizer comprising a hollow plastic body having two plastic inlets and an outlet formed by a floor and upstanding sidewalls, a cover for closing the channel and a plurality of snap locks for securing the cover to the channel body.

23. A T-shaped cable organizer as described in claim 18 wherein the body has a flat bottom surface and a length of two-sided adhesive tape secured to said flat bottom surface.
